(19) United States
(12) Patent Application Publication
(10) Pub. No.: US 2025/0045098 A1
(43) Pub. Date: Feb. 6, 2025

(54) THREAD POOL MANAGEMENT FOR DATA TRANSFER BETWEEN INTEGRATED PRODUCTS

(71) Applicant: VMware LLC, Palo Alto, CA (US)

(72) Inventors: AMIT KOLKAR, Pune (IN); KALYAN DEVARAKONDA, Bangalore (IN); SRIKANT KOTTA, Bangalore (IN); RANJIT NAYAK, Bangalore (IN)

(21) Appl. No.: 18/380,160

(22) Filed: Oct. 14, 2023

(30) Foreign Application Priority Data
Jul. 31, 2023 (IN) 202341051459
Aug. 30, 2023 (IN) 202341051459

(51) Int. Cl. G06F 9/48; G06F 9/54

(52) U.S. Cl. CPC G06F 9/4881; G06F 9/541

(57) ABSTRACT

An example method may include executing, using an integration plugin installed on a first integrated product running in a first management node, a first schedule job to assess the first management node for a specified period of time or for a specified number of assessments. Further, a check is made to determine, using the integration plugin, whether a thread in a thread pool of the first management node is idle after the specified period of time or the specified number of assessments. Based on the whether the thread is idle, a number of threads allocated for data transfer between a second management node executing a second integrated product and the first management node may be altered using the integration plugin. Based on the altered number of threads, the data transfer between the second management node and the first management node may be performed using the integration plugin.

### RELATED APPLICATIONS

Benefit is claimed under 35 U.S.C. 119 (a)-(d) to Foreign Provisional Application Serial. No. 202341051459 filed in India entitled “THREAD POOL MANAGEMENT FOR DATA IMPORT BETWEEN INTEGRATED PRODUCTS”, on Jul. 31, 2023, and Foreign Non-Provisional application No. 202341051459 filed in India entitled “THREAD POOL MANAGEMENT FOR DATA TRANSFER BETWEEN INTEGRATED PRODUCTS”, on Aug. 30, 2023, by VMware, Inc., which is herein incorporated in its entirety by reference for all purposes.

### TECHNICAL FIELD

The present disclosure relates to computing environments, and more particularly to methods, techniques, and systems for altering a number of threads allocated for data transfer between integrated products in the computing environment.

### BACKGROUND

Cloud service providers offering hybrid and/or multi-cloud services to customers have the challenge of providing orchestration of a vast number of legacy infrastructures of multiple customers and multi-cloud environments (e.g., Private/Public/Various brands GCP, AWS, Azure, VMware, OracleVM, and the like). Virtualization of computing infrastructures is a fundamental process that powers cloud computing in order to provide services to the customers requesting services on a cloud platform through a portal. However, when the features of the virtualization software are not well integrated with a services management unit of the cloud platform, the customers may not be able to access certain functionalities of the cloud platform, which can have a negative impact on the quality of the service provided by said cloud platform.

Some issues may inhibit the adoption of the infrastructure automation platform (e.g., VMware Aria® Automation™, an automation platform to build and manage modern applications). For example, customers using the ServiceNow (e.g., a cloud service orchestration/processing module) cloud management portal (CMP) are not able to leverage said ServiceNow cloud management portal (CMP) to provision services via the infrastructure automation platform. Only basic integration with a cloud computing platform (e.g., VMware® vSphere™, a virtualization software), is present. This only includes provisioning and powers state changes services. The very basic integration does not allow to manage vSphere Virtual Machines (VMs) using the cloud management portal. The implication is that customers using ServiceNow Cloud management portal (CMP) are not able to get fully featured infrastructure automation platform's capabilities.

### BRIEF DESCRIPTION OF THE DRAWINGS

FIG. 1 is a block diagram of an example computing environment, depicting a management node to manage a number of threads allocated for data transfer between a first cloud-based automation platform and a second cloud-based automation platform;

FIG. 2 is a block diagram of an example computing environment, depicting various components of an integration plugin to import inventory data from a VMware Aria Automation platform;

FIG. 3 is a flow diagram illustrating an example method for altering a number of threads for leveraging management functions performed by different integrated products;

FIG. 4 is a flow diagram illustrating an example method for selecting one or more topics for performing data import based on a number of available threads;

FIG. 5 is an example graph, depicting a number of worker threads allocated for data import based on other activities running on a third-party cloud-based platform;

FIG. 6 is a flow diagram illustrating an example method for altering a number of threads for data import from an integrating product to an integrated product;

FIG. 7 is a block diagram of an example management node including non-transitory computer-readable storage medium storing instructions to alter a number of threads allocated for data import from a second integrated product to a first integrated product.

The drawings described herein are for illustrative purposes and are not intended to limit the scope of the present subject matter in any way.

### DETAILED DESCRIPTION

Examples described herein may provide an enhanced computer-based and/or network-based method, technique, and system to manage a thread pool for data transfer between integrated products in the computing environment. The paragraphs to present an overview of the computing environment, existing methods to leverage functionalities of an integrated product through the integrating product, and drawbacks associated with the existing methods.

The computing environment may be a virtual computing environment (e.g., a cloud computing environment, a virtualized environment, and the like). The virtual computing environment may be a pool or collection of cloud infrastructure resources designed for enterprise needs. The resources may be a processor (e.g., a central processing unit (CPU)), memory (e.g., random-access memory (RAM)), storage (e.g., disk space), and networking (e.g., bandwidth). Further, the virtual computing environment may be a virtual representation of the physical data center, complete with servers, storage clusters, and networking components, all of which may reside in virtual space being hosted by one or more physical data centers. The virtual computing environment may include multiple physical computers (e.g., servers) executing different computing-instances or workloads (e.g., virtual machines, containers, and the like). The workloads may execute different types of applications or software products. Thus, the computing environment may include multiple endpoints such as physical host computing systems, virtual machines, software defined data centers (SDDCs), containers, and/or the like.

An example cloud computing environment is VMware vSphere®. The cloud computing environment may include one or more computing platforms (i.e., infrastructure automation platforms) that support the creation, deployment, and management of virtual machine-based cloud applications. One such platform is VMware Aria® Automation™ (i.e., formerly known as vRealize Automation®), which is commercially available from VMware. While the vRealize Automation® is one example of a cloud deployment platform, it should be noted that any computing platform that supports the creation and deployment of virtualized cloud applications is within the scope of the present embodiment. In such virtual computing environments, the computing platform can be used to build and manage a multi-vendor cloud infrastructure.

As the customers move towards leveraging public and private clouds for their workloads, it is increasingly difficult to deploy and manage them. Aspects such as cost analysis and monitoring may make it increasingly complex for the customers having a bigger scale. The infrastructure automation platforms such as VMware Aria® Automation™ may help in solving these problems not just for provisioning but also for any Day-2 operations. However, customers using other third-party cloud-based platform's (e.g., ServiceNow, a cloud-based platform for automating IT management workflows) cloud management portal (CMP) may not be able to leverage said cloud management portal (CMP) to provision services via the infrastructure automation platform.

Some issues that inhibit the adoption of the infrastructure automation platform may include:
While the infrastructure automation platform, such as VMware Aria® Automation™, may provide great and unique value propositions, customers may already have tools (e.g., ServiceNow) that are deployed for automating the information technology (IT) management workflows. This creates a barrier for greenfield customers to be able to adopt and switch over to the other infrastructure automation platforms.
Some third-party cloud-based platforms may not have capabilities like VMware Aria® Automation™. However, by adding external components/plugins to such third-party cloud-based platforms, the capabilities/functionalities provided to the customers can be augmented to provide both VMware Aria® Automation™ and the third-party cloud-based platform's capabilities/functionalities.
While some infrastructure automation platforms have application program interface (API) first approach, there is often no criteria defined on how the external third-party cloud-based platforms could be integrated with such infrastructure automation platforms for better seamless experience for the customers.

For the integration of the infrastructure automation platform to work with third-party cloud-based platforms, the following aspects has to be considered:
Data import between the third-party cloud-based platforms and the infrastructure automation platform.
Data sync/consistency between the third-party cloud-based platforms and the infrastructure automation platform.
Ability to orchestrate an action triggered in the third-party cloud-based platforms to the infrastructure automation platform.

In some third-party cloud-based platforms, there could be resource limitations imposed in terms of concurrency, number of threads, and the like, which are shared between various use cases such as customer actions in a user interface (UI), Aria® Automation™ integration, third party integrations into the external tools other than the Aria® Automation™, other system level operations, and the like. While the integrations with the infrastructure automation platform could be customer specific, there is no clear strategy with which the customers shall be able to tune the concurrency for optimal utilization of resources without affecting the user experience.

Examples described herein may provide a management node comprising a first cloud-based automation platform (i.e., a third-party cloud-based platform) and an integration plugin installed on the first cloud-based automation platform to leverage functionalities of a second cloud-based automation platform (e.g., VMware Aria® Automation™) through the first cloud-based automation platform. During operation, the integration plugin may manage (e.g., increase or decrease) a number of allocated threads for data import of the third-party integration plugin based on a number of idle/free worker threads available in the first cloud-based automation platform.

In an example, the integration plugin may execute a first schedule job to assess the first management node for a specified period of time or for a specified number of assessments. Further, the integration plugin may determine whether a thread in a thread pool of the management node is idle after the specified period of time or the specified number of assessments. Based on the whether the thread is idle, the integration plugin may alter a number of threads allocated for data transfer with the second cloud-based automation platform. Furthermore, the integration plugin may perform the data transfer between the second cloud-based automation platform and the first cloud-based automation platform based on the altered number of threads.

Examples described herein may have the following advantages:
Auto-calibrate the number of threads that could be allocated for the data transfer (e.g., data import) depending upon the number of idle/free worker threads available on the management node. The need of auto-calibrated concurrency is common problem and is needed in any of the integration products. This is especially true when the third-party cloud-based platform has more than one integration and multiple users working on the third-party cloud-based platform with various use cases at the same time.
Each integrating third-party cloud-based platform (e.g., ServiceNow) may allow limited resources in terms of worker threads. Examples described herein may work efficiently in using the resources available at disposal.
Improves the user experience as the user requests may not go into a wait mode even during data transfer/import operations.
The proposed solution can facilitate to claim more threads when there are no other active tasks being executed in the management node.
The proposed solution may offer to alleviate the load by offering worker threads when other components of the management node need them.

In the following description, for purposes of explanation, numerous specific details are set forth in order to provide a thorough understanding of the present techniques. However, the example apparatuses, devices, and systems, may be practiced without these specific details. Reference in the specification to “an example” or similar language means that a particular feature, structure, or characteristic described may be included in at least that one example but may not be in other examples.

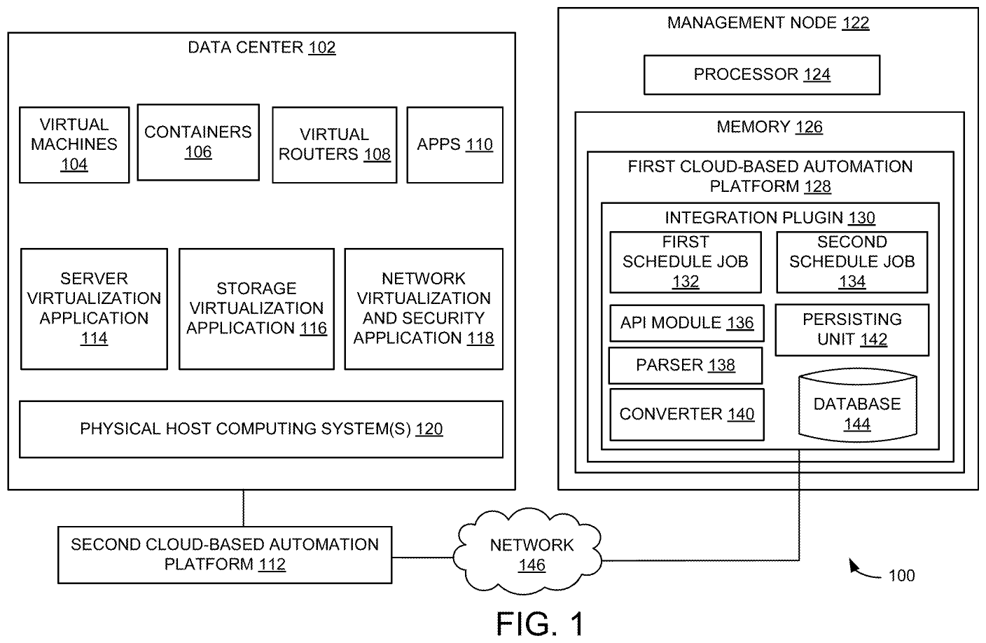

Referring now to the figures, FIG. 1 is a block diagram of an example computing environment 100, depicting a management node 122 to manage a number of threads allocated for data transfer between a first cloud-based automation platform 128 and a second cloud-based automation platform 112. Computing environment 100 may be based on the deployment of physical resources across a network, virtualizing the physical resources into virtual resources, and provisioning the virtual resources in a data center 102 for use across cloud computing services and applications. Data center 102 may refer to a centralized physical facility where servers, network, storage, and other information technology equipment that support business operations exist. Further, components or resources in data center 102 include or facilitate business-critical applications, services, data, and the like.

For example, data center 102 may be a software-defined data center (SDDC) with hyperconverged infrastructure (HCI). In SDDC with hyper-converged infrastructure, networking, storage, processing, and security may be virtualized and delivered as a service. The hyper-converged infrastructure may combine a virtualization platform such as a hypervisor, virtualized software-defined storage, and virtualized networking in deployment of data center 102. For example, data center 102 may include different resources such as a server virtualization application 114 (e.g., vSphere of VMware®), a storage virtualization application 116 (e.g., vSAN of VMware®), a network virtualization and security application 118 (e.g., NSX of VMware®), physical host computing systems 120 (e.g., ESXi servers), or any combination thereof.

Further, computing environment 100 may include second cloud-based automation platform 112 to deploy different resources and manage different workloads such as virtual machines 104, containers 106, virtual routers 108, applications 110, and the like in data center 102. Second cloud-based automation platform 112 may run in a compute node such as a physical server, virtual machine, or the like. Second cloud-based automation platform 112 may be deployed inside or outside data center 102 and responsible for managing a single data center or multiple data centers. Virtual machines 104, in some examples, may operate with their own guest operating systems on a physical computing device using resources of the physical computing device virtualized by virtualization software (e.g., a hypervisor, a virtual machine monitor, and the like). Containers 106 are data computer nodes that run on top of the host operating systems without the need for a hypervisor or separate operating system.

Second cloud-based automation platform 112 may be used for provisioning and configuring information technology (IT) resources and automating the delivery of container-based applications. An example of second cloud-based automation platform 112 may be VMware Aria® Automation™ (formerly known as vRealize Automation®), a modern infrastructure automation platform designed to help organizations deliver self-service and multi-cloud automation. The vRealize Automation® may be a cloud management platform that can be used to build and manage a multi-vendor cloud infrastructure. The vRealize Automation® provides a plurality of services that enable self-provisioning of virtual machines in private and public cloud environments, physical machines (install OEM images), applications, and IT services according to policies defined by administrators.

For example, the vRealize Automation® may include a cloud assembly service to create and deploy machines, applications, and services to a cloud infrastructure, a code stream service to provide a continuous integration and delivery tool for software, and a broker service to provide a user interface to non-administrative users to develop and build templates for the cloud infrastructure when administrators do not need full access for building and developing such templates. The example vRealize Automation® may include a plurality of other services, not described herein, to facilitate building and managing the multi-vendor cloud infrastructure. In some examples, the example vRealize Automation® may be offered as an on-premise (e.g., on-prem) software solution wherein the vRealize Automation® is provided to an example customer to run on the customer servers and customer hardware. In other examples, the example vRealize Automation® may be offered as a Software as a Service (e.g., SaaS) wherein at least one instance of the vRealize Automation® is deployed on a cloud provider (e.g., Amazon Web Services).

As shown in FIG. 1, data center 102 may be communicatively connected to management node 122 via network 146. For example, network 146 can be a managed Internet protocol (IP) network administered by a service provider. For example, network 146 may be implemented using wireless protocols and technologies, such as Wi-Fi, WiMAX, and the like. In other examples, network 146 can also be a packet-switched network such as a local area network, wide area network, metropolitan area network, Internet network, or other similar type of network environment. In yet other examples, network 146 may be a fixed wireless network, a wireless local area network (LAN), a wireless wide area network (WAN), a personal area network (PAN), a virtual private network (VPN), intranet or other suitable network system and includes equipment for receiving and transmitting signals.

Management node 122 may include a processor 124. Processor 124 may refer to, for example, a central processing unit (CPU), a semiconductor-based microprocessor, a digital signal processor (DSP) such as a digital image processing unit, or other hardware devices or processing elements suitable to retrieve and execute instructions stored in a storage medium, or suitable combinations thereof. Processor 124 may, for example, include single or multiple cores on a chip, multiple cores across multiple chips, multiple cores across multiple devices, or suitable combinations thereof. Processor 124 may be functional to fetch, decode, and execute instructions as described herein. Further, management node 122 includes memory 126 coupled to processor 124. Memory 126 includes first cloud-based automation platform 128 running therein.

For example, first cloud-based automation platform 128 may be ServiceNow or any other third-party cloud-based platform. For example, the ServiceNow is a cloud-based platform that is used for automating IT management workflows. The platform specializes in IT service management, IT operations management, and IT business management. After joining the technology partner program (TPP), every partner has two vendor instances provisioned for them. These are standard instances but have some special features and applications to specifically support ServiceNow Technology Partners. Vendor instance may be a node with dedicated resources and worker threads to serve the requests raised by logged in users in order to achieve the above-mentioned platform capabilities. Like most of the other cloud-based platforms, the ServiceNow provides a platform to integrate with third-party products to explore ServiceNow features through a ServiceNow plugin called Scoped Application. Such applications are developed by the third-party vendors (e.g., VMware) and certified by ServiceNow certification team.

Further, management node 122 may include an integration plugin 130 installed on first cloud-based automation platform 128. An example integration plugin 130 is a software add-on that is installed on first cloud-based automation platform 128, enhancing its capabilities. Further, second cloud-based automation platform 112 (i.e., integrated product) may provide first cloud-based automation platform's 128 (i.e., an integrating product's) integration plugin 130 that extends the integrated product's functionalities like provisioning and monitoring of the deployments and applications through the integrating product's cloud management portal. For example, VMware Aria® Automation™ provides a ServiceNow integration plugin called “VMware Aria Automation Plugin” that extends the Aria Automation functionalities like provisioning and monitoring of the deployments and applications through the ServiceNow platform.

The Aria Automation plugin may not just extend the Aria Automation's provisioning functionality in the ServiceNow, but the plugin also makes use of ServiceNow's Out-Of-The-Box features like approval, incident management, email notifications, and the like. Similar to any other integration that replicates the functionality of one product into another, the plugin will be fetching inventory data from the integrated product into the integrating product. In the above example, the Aria Automation plugin on the ServiceNow may have to fetch the inventory data from the Aria® Automation™ to make use of the same to replicate the functionality.

Thus, integration plugin 130 installed on first cloud-based automation platform 128 may be used to leverage functionalities of second cloud-based automation platform 112 through first cloud-based automation platform's 128 cloud management portal. During operation, integration plugin 130 may be operable to execute a first schedule job 132 to assess management node 122 for a specified period of time or for a specified number of assessments.

Further, integration plugin 130 may be operable to determine whether a thread(s) in a thread pool of management node 122 is idle after the specified period of time or the specified number of assessments. In an example, integration plugin 130 may execute first schedule job 132 to assess a transaction table that stores statistics data (e.g., an average execution time, total number executions, minimum execution time, maximum execution time, standard deviation, and the like) representing active transactions in management node 122 and information of threads that are processing the active transactions. Then, integration plugin 130 may determine whether the thread is idle based on the assessment.

Furthermore, integration plugin 130 may be operable to alter a number of threads allocated for data transfer with second cloud-based automation platform 112 based on the whether the thread is idle. In an example, integration plugin 130 may increase the number of threads allocated for the data transfer between second cloud-based automation platform 112 and first cloud-based automation platform 128 when the thread is found idle in management node 122 after the specified period of time or the specified number of assessments. In another example, integration plugin 130 may reduce the number of threads allocated for the data transfer between second cloud-based automation platform 112 and first cloud-based automation platform 128 when no thread is found idle in the management node after the specified period of time or the specified number of assessments.

In some other examples, integration plugin 130 may configure a maximum number and a minimum number of threads that could be allocated for the data transfer of integration plugin 130. In some examples, the maximum number and a minimum number of threads that could be allocated for the data transfer can be configured as a percentage of the total number of threads available on first cloud-based automation platform 128. In this example, integration plugin 130 may evaluate traffic data and transaction data that are being performed in management node 122. Based on the traffic data and the transaction data, integration plugin 130 may auto-calibrate the maximum number and the minimum number of threads that could be allocated for the data transfer. Further, integration plugin 130 may increase the number of threads up to the maximum number that could be allocated for the data transfer or reduce the number of threads up to the minimum number that could be allocated for the data transfer based on other operations being carried out in management node 122.

Also, integration plugin 130 may be operable to perform the data transfer between second cloud-based automation platform 112 and first cloud-based automation platform 128 based on the altered number of threads. An example of data transfer may include data import from second cloud-based automation platform 112 to first cloud-based automation platform 128. In this example, integration plugin 130 may include a second schedule job 134 that, when executed, may invoke a job queue by inserting different topics into the job queue and triggers a business rule to import the data for each topic in the job queue. An example topic may include a project, a catalogue item, a deployment, a deployment action, a resource, and a resource action. Further, integration plugin 130 may perform the data import for each topic from second cloud-based automation platform 128 to first cloud-based automation platform 112 by processing the topics in parallel using the altered number of threads.

In the above example, second schedule job 134, when executed, may perform the data import for each topic by:
determining a number of available threads for the data import based on the altered number of threads and the number of threads being occupied for the data import,
selecting one or more topics for performing the data import based on the number of available threads, and
triggering the business rule to perform the data import for the selected topics by occupying the available threads.

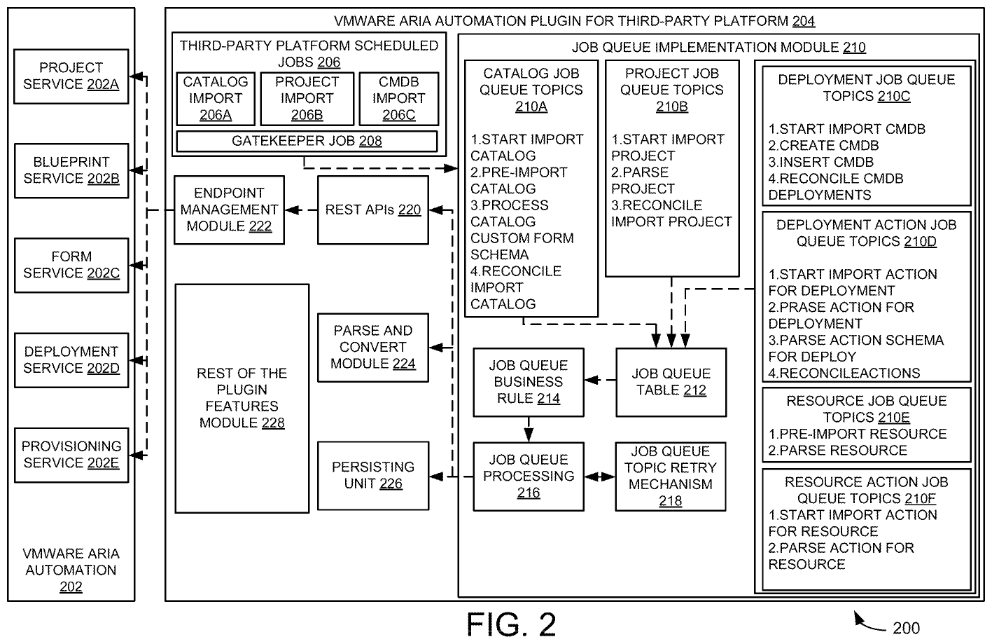

Further, integration plugin 130 may include an API module 136 that, upon triggering the business rule, may obtain an API response from second cloud-based automation platform 112 by querying second cloud-based automation platform 112 using an application program interface (API) call. The API response may include the data associated with second cloud-based automation platform 112. Further, integration plugin 130 may include a parser 138 to parse the API response and a data converter 140 to convert the parsed API response into a defined format corresponding to first cloud-based automation platform 128. The defined format may refer to a format that cloud-based automation platform 128 can understand. Furthermore, integration plugin 130 may include a persisting unit 142 to persist the converted API response in a database 144 associated with first cloud-based automation platform 128 by making a platform call that enables integration plugin 130 to interact with a database 144. An example of data import from second cloud-based automation platform 112 is explained in FIG. 2.

Further, integration plugin 130 may enable the management functions of second cloud-based automation platform 112 to be performed through first cloud-based automation platform 128 using the transferred data (i.e., imported data). Thus, examples described herein may increase or reduce the number of allocated threads for data import of the third-party integration plugin 130 depending upon the number of idle/free worker threads available on the first cloud-based automation platform 128.

In some examples, the functionalities described in FIG. 1, in relation to instructions to implement functions of integration plugin 130 including first schedule job 132, second schedule job 134, API module 136, parser 138, converter 140, and persisting unit 142, and any additional instructions described herein in relation to the storage medium, may be implemented as engines or modules including any combination of hardware and programming to implement the functionalities of the modules or engines described herein. The functions of integration plugin 130 may also be implemented by a processor. In examples described herein, the processor may include, for example, one processor or multiple processors included in a single device or distributed across multiple devices.

Further, computing environment 100 illustrated in FIG. 1 is shown purely for purposes of illustration and is not intended to be in any way inclusive or limiting to the embodiments that are described herein. For example, a typical computing environment would include many more remote servers (e.g., physical host computing systems), which may be distributed over multiple data centers, which might include many other types of devices, such as switches, power supplies, cooling systems, environmental controls, and the like, which are not illustrated herein. It will be apparent to one of ordinary skill in the art that the example shown in FIG. 1, as well as all other figures in this disclosure have been simplified for ease of understanding and are not intended to be exhaustive or limiting to the scope of the idea.

FIG. 2 is a block diagram of an example computing environment 200, depicting various components of an integration plugin (e.g., VMware Aria Automation Plugin 204) to import inventory data from VMware Aria Automation platform 202. VMware Aria Automation Plugin 204 can be installed in a third-party cloud-based platform such as ServiceNow platform. As shown in FIG. 2, VMware Aria Automation plugin 204 may include scheduled jobs 206. For example, the third-party cloud-based platform such as ServiceNow has scheduled Jobs 206, which acts like a cron job and triggers on a schedule to run a piece of code (e.g., JavaScript). An example of schedule jobs 206 may include catalogue import 206A, project import 206B, a configuration management database (CMDB) import 206C, and the like.

VMware Aria Automation Plugin 204 for the third-party cloud-based platform makes use of schedule jobs 206 to import the inventory items like projects, catalogue items, and CMDB, and the like. Schedule jobs 206, once triggered, may interact with a job queue implementation module 210 to proceed with importing the data from Aria Automation platform 202 into the third-party cloud-based platform (e.g., ServiceNow). Job queue implementation module 210 may makes use of a job queue table 212 and a job queue business rule 214 to import the data in parallel using the third-party cloud-based platform's thread pool underneath the third-party cloud-based platform.

As shown in FIG. 2, VMware Aria Automation plugin 204 may include job queue implementation module 210, which may get invoked from schedule jobs 206A, 206B, and 206C. Each block of inventory item shown above has different topics (e.g., catalogue job queue topics 210A, project job queue topics 210B, deployment job queue topics 210C, deployment action job queue topics 210D, resource job queue topics 210E, and resource action job queue topics 210F) with which VMware Aria Automation plugin 204 makes entry into job queue table 212 that eventually triggers a business rule 214 for that topic. Business rule 214 on job queue table 212 may handle all the topics in a switch-case and perform further processing of the topic by invoking further methods from different scripts (e.g., using a job queue processing module 216). In this example, each topic is intended to do either a Representational State Transfer (REST) application programming interface (API) call, parse and convert API response, persist the data or the combination of these steps. A retry mechanism/logic 218 may ensure that if some processing breaks in between, data integrity is made sure of by retrying the same operation for a number of times defined in a configurable parameter in the third-party cloud-based platform (ServiceNow) properties. VMware Aria Automation Plugin for ServiceNow needs to fetch projects, catalogue items, deployments, resources, actions for both deployments, resources, and the like in order to replicate the provisioning and monitoring functionality of Aria Automation into ServiceNow. Every inventory item has to go through following modules of the Aria Automation plugin 204 to be usable in the third-party cloud-based platform such as the ServiceNow.

As shown in FIG. 2, VMware Aria Automation plugin 204 may include a REST API module 220. REST API module 220 may be responsible for making a REST API call to Aria Automation 202 to fetch the inventory item and/or its supporting schema from various services (e.g., project service 202A, blueprint service 202B, form service 202C, deployment service 202D, and provisioning service 202E) deployed in Aria Automation 202. In an example, REST API module 220 may communicate with Aria Automation 202 via an endpoint management module 222 that controls and enables secure access to endpoint devices (i.e., Aria Automation 202). This is the first step in the process of data import.

In some examples, each of the above-mentioned inventory item needs to be fetched with one or multiple REST API calls and most of them would also include a pagination in case if the data on Aria Automation 202 is large in number. Pagination is a way of fetching say thousands of items in the REST API response in a batched fashion. Fetching all thousands of items in one round would make the call bulky and there is a chance of failing due to network glitches or buffer overflow. Pagination makes the batches of the data with less data in each round and making multiple REST API calls with proper page size and offset can help getting such large amounts of data from the server.

Further, VMware Aria Automation plugin 204 may include a parse and convert module 224. Parse and convert module 224 may be responsible for dealing with the response received from REST API module 220. As the REST API returns a response, parse and convert module 224 may understand the response and parse the response. Further, parse and convert module 224 may convert the parsed and understood response into third-party cloud-based platform entities (e.g., ServiceNow entities).

After the REST API call is made and data is received as a JSON response, parse and convert module 224 has to then parse the JSON response and convert it into something that the third-party cloud-based platform can understand. For example, a catalogue item having custom form variables depending on another variable on the form. This data is received in the Aria Automation plugin 204 in the form of JSON format and finally needs to be converted into the third-party cloud-based platform catalogue client script to resolve the dependency when the catalogue item form loads in the third-party cloud-based platform. Few examples of such conversions for the ServiceNow platform are mentioned below:
Aria automation's 202 Blueprints are ServiceNow's catalogue items.
Form properties of Aria Automation 202 custom form are ServiceNow's variables of catalogue item.
Dependencies of custom form properties at Aria Automation 202 are ServiceNow's Catalogue client scripts.
Projects at Aria Automation 202 are ServiceNow's Catalogue item categories.

Further, VMware Aria Automation plugin 204 may include a persisting unit 226. VMware Aria Automation plugin 204 may make use of a Glide Record (e.g., a way to interact with the ServiceNow database from a script) to perform Create, Read, Update and Delete (CRUD) operations on the parsed and converted inventory items and then save the inventory items in a ServiceNow database. After parsing and processing the JSON response from the REST API, finally, persisting unit 226 may persist the data into the third-party cloud-based platform's database by making some platform calls that enables plugin to interact with the third-party cloud-based platform's database.

Furthermore, VMware Aria Automation plugin 204 may include other modules such as rest of the plugin features module 228 to perform other activities/functions of the plugin. Importing the data and saving the inventory data into the ServiceNow's database locally makes the user experience better and faster because when the form loads, the data is being fetched from the database and not from Aria Automation platform 202.

If the Aria Automation plugin 204 has to fetch all the inventory items mentioned above by following the three processing steps sequentially, it would take significantly long time for the plugin to fetch the data. The other option is a multi-threaded environment working in parallel on these processing steps for different inventory items. However, the third-party cloud-based platforms may not provide all the functionalities a developer would need to accomplish the multi-threaded environment programmatically but that does not mean that the third-party cloud-based platforms do not have thread pool underneath the platform. For example, the ServiceNow has business rules that run if a certain operation happens on a table record in the database of the ServiceNow. When this business rule runs, it executes a piece of JavaScript code and this execution happens on a new thread spawned by the ServiceNow platform called worker thread. VMware Aria Automation plugin for ServiceNow has made use of business rule provided by the ServiceNow to convert it into a multi-threaded environment for this import job by using Job Queue Architecture explained in FIG. 2.

According to the job queue architecture, schedule jobs 206 may invoke the job queue by inserting different topics into job queue table 212 that can trigger business rule 214 on job queue table 212 for each topic and process the topics in parallel. As third-party cloud-based platforms (e.g., ServiceNow instances) are nothing but a node with limited resources, typically, one vendor instance of ServiceNow would have 16 worker threads, i.e., there could be only 16 parallel processing that can be carried out on the ServiceNow instance. Usually, the ServiceNow users may have multiple applications installed on the ServiceNow instance and multiple end users may use the instance at the same time. The number of worker threads may be allocated on a first come first served basis and once the ServiceNow instance is out of the worker threads, all further user requests or tasks goes in loading/waiting state until the next worker thread is available to process request/task.

Typically, as soon as the data import of VMware Aria Automation plugin 204 begins, all the schedule jobs (e.g., 206A, 206B, and 206C) start pumping the job queue topics into job queue table 212 and until the whole data is imported by processing all the job queue topics, all the available threads on the ServiceNow vendor instance are kept busy just for the data import. This may have a significant impact on other tasks and requests those are being made by different logged in users, because their requests go to a loading/hang state until a worker thread(s) is available to process them. This is because VMware Aria Automation plugin 204 for ServiceNow may not have any control over how many worker threads should be allocated for data import process and how many should be left alone for the rest of the activities happening on the instance.

VMware Aria Automation plugin 204 described herein may make use of the active transactions data stored by the third-party platform like ServiceNow in a table to determine if the number of threads allocated for the data import needs to be reduced or increased depending upon number of idle/free worker threads available on the third-party platform as follows:
A scheduled job may trigger after every “Average Time Taken by Worker to Finish” seconds and assess the transaction table to list idle/free worker threads.
If any worker thread/threads were found to be idle/free even after ‘n’ assessments, they are eligible for consumption for operations such as data import/processing/persistence to improve the performance and achieve the data integrity sooner.
Once consumed, the system would release back the worker thread(s) to see if it is going to be claimed by other plugins/components/UIs etc.
If threads are busy for ‘n’ consecutive assessments, it would imply that a deficiency of worker threads on the third-party platform. This is an opportunity for the worker threads for data import of the third-party integration plugin to offer one thread (so long as the number of threads is more than a minimum threshold) for other operations.

Further, the third-party cloud-based platform such as ServiceNow may maintain a history of transactions performed by the worker threads and keep the data like a name of the worker thread, how many transactions it performed till date, what was the mean time for those transactions, and the like.

In the above example, the “Average Time Taken by Worker to Finish” can be calculated as follows:

$$( ( worker - 1 - \# Txn * worker - 1 - mean ) + ( worker - 2 - \# Txn * worker - 2 - mean ) + ... + ( worker - n - \# Txn * worker - n - mean ) ) / n$$

Where “n” refers to a number of worker threads in the third-party platform, worker-1 to worker-n are the names of the worker threads, “#Txn” refers to a number of transactions performed by each worker thread till date, and “mean” refers to a mean time taken for the transactions performed by each worker thread.

Further, VMware Aria Automation plugin 204 described in FIG. 2 may introduce a gatekeeper into a state flow of the job queue topics. VMware Aria Automation plugin 204 may include a gatekeeper job 208, which monitors the number of worker threads under use by the data import operation of VMware Aria Automation plugin 204 and takes a call whether to allow a next topic to be taken up by an available worker thread or not. This can be achieved by making the following changes to job queue implementation 210:
Job queue table 212 can have an additional field called state and can hold one of the values out of “Ready”, “Processing”, “Completed”, and “Error”.
Every new entry into the job queue table 212 can be made with state as “Ready”.
A configurable system property on the third-party cloud-based platform may hold the number of allowed threads allocated specifically for the data import operation of VMware Aria Automation plugin 204.
Gatekeeper schedule job 208 may perform the following:
   a. Keeping a track of how many job queue entries are in the processing state using the additional field of job queue table 212.
   b. Determining available threads for the data import by doing a math of the allowed threads for data import (i.e., the altered number) minus number of threads in the processing state currently.
   c. Based on the available threads, take those many job queue entries from the queue and change the state from “Ready”/“Error” to “Processing”.
Change the condition of business rule 214 to trigger only when the state is changed to “Processing”. Thus, when the job queue topic was added with “Ready” state, business rule 214 will not trigger, and worker threads will not be utilised. Only after gatekeeper job 208 moves the topic from “Ready” to “Processing” state, business rule 214 may trigger to perform the activity by occupying the worker thread.

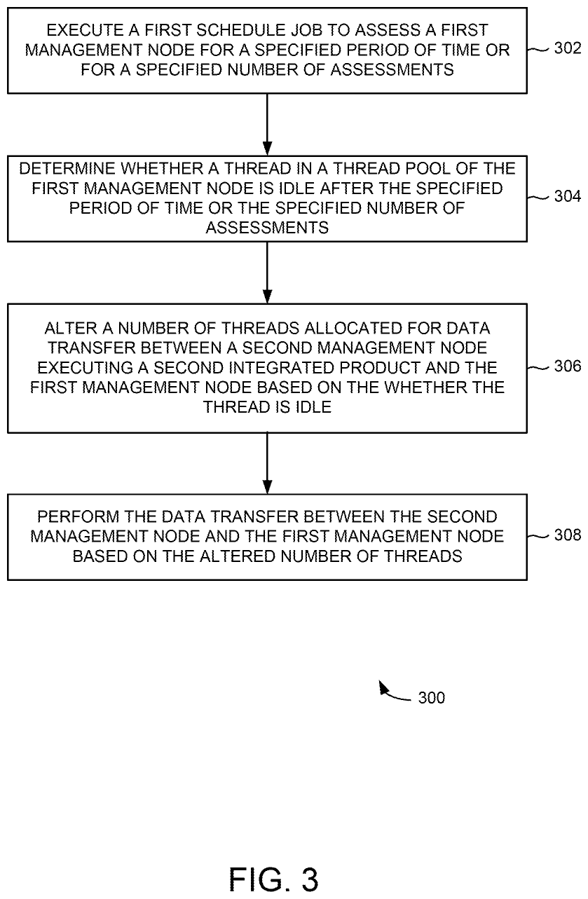

FIG. 3 is a flow diagram illustrating an example method 300 for altering a number of threads for leveraging management functions performed by different integrated products. Example method 300 depicted in FIG. 3 represents generalized illustrations, and other processes may be added, or existing processes may be removed, modified, or rearranged without departing from the scope and spirit of the present application. In addition, method 300 may represent instructions stored on a computer-readable storage medium that, when executed, may cause a processor to respond, to perform actions, to change states, and/or to make decisions. Alternatively, method 300 may represent functions and/or actions performed by functionally equivalent circuits like analog circuits, digital signal processing circuits, application specific integrated circuits (ASICs), or other hardware components associated with the system. Furthermore, the flow chart is not intended to limit the implementation of the present application, but the flow chart illustrates functional information to design/fabricate circuits, generate computer-readable instructions, or use a combination of hardware and computer-readable instructions to perform the illustrated processes.

At 302, a first schedule job may be executed, using an integration plugin installed on a first integrated product running in a first management node, to assess the first management node for a specified period of time or for a specified number of assessments. At 304, a check may be made to determine, using the integration plugin, whether a thread in a thread pool of the first management node is idle after the specified period of time or the specified number of assessments.

At 306, a number of threads allocated for data transfer between a second management node executing a second integrated product and the first management node may be altered, using the integration plugin, based on the whether the thread is idle. In an example, a transaction table that stores statistics data representing active transactions in the first management node and information of threads that are processing the active transactions may be assessed. Then, the check is made to determine whether the thread is idle based on the assessment.

In an example, altering the number of threads allocated for the data transfer may include increasing the number of threads allocated for the data transfer between the second management node and the first management node when the thread is found idle in the first management node after the specified period of time or the specified number of assessments. In another example, altering the number of threads allocated for the data transfer may include reducing the number of threads allocated for the data transfer between the second management node and the first management node when no thread is found idle in the first management node after the specified period of time or the specified number of assessments.

In other examples, altering the number of threads allocated for the data transfer may include configuring a maximum number and a minimum number of threads that could be allocated for the data transfer of the integration plugin. In this example, traffic data and transaction data that are being performed in the first management node may be evaluated. Then, the maximum number and the minimum number of threads that could be allocated for the data transfer may be auto calibrated based on the traffic data and the transaction data. Based on other operations being carried out in the first management node, increasing the number of threads up to the maximum number that could be allocated for the data transfer or reducing the number of threads up to the minimum number that could be allocated for the data transfer.

At 308, the data transfer between the second management node and the first management node may be performed, using the integration plugin, based on the altered number of threads. In an example, performing the data transfer between the second management node and the first management node may include executing a second schedule job that invokes a job queue by inserting different topics into the job queue and triggers a business rule to import the data for each topic in the job queue. In this example, the data import for each topic may be performed from the second management node to the first management node by processing the topics in parallel using the altered number of threads. For example, performing the data import for each topic may include:
determining, by the second schedule job, a number of available threads for the data import based on the altered number of threads and the number of threads being occupied for the data import,
selecting, by the second schedule job, one or more topics for performing the data import based on the number of available threads, and
triggering, by the second schedule job, the business rule to perform the data import for the selected topics by occupying the available threads.

In some examples, the data transfer between the second management node and the first management node may be performed by:
obtaining an API response from the second management node by querying the second management node using an application program interface (API) call, the API response including the data associated with the second integrated product;
parsing the API response,
converting the parsed API response into a defined format corresponding to the first integrated product, and
persisting the converted API response in a database associated with the first integrated product by making a platform call that enables the integration plugin to interact with the database.

Upon completing the data transfer, the management functions of the second integrated product may be enabled to perform through the first integrated product using the transferred data.

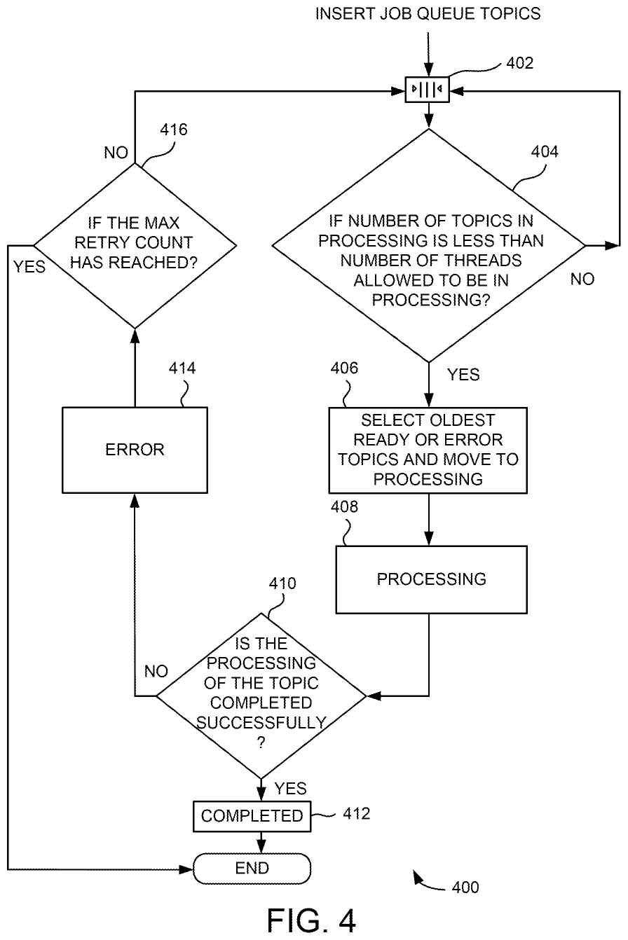

FIG. 4 is a flow diagram illustrating an example method 400 for selecting one or more topics for performing the data import based on a number of available threads. In an example, consider that a job queue table includes an additional field called state and can hold one of the values out of “Ready”, “Processing”, “Completed”, and “Error”. At 402, each job queue topic is inserted into the job queue table with “ready” state so that this topic remains in the queue until a thread to process it is available. At 404, a check is made to determine if a number of topics in processing is less than a number of threads allowed to be in processing (e.g., number of allowed threads is configurable). When the number of topics in processing is less than the number of threads allowed to be in processing, at 406, oldest ready or error topics are selected and moved to processing. At 408, the selected oldest ready or error topics may be processed. In this example, as soon as job queue topic goes to processing state, a business rule triggers and finishes the intended processing of the topic. The business rule may make a rest API call to the integrated product (e.g., the Aria Automation), parse the API response, and/or create ServiceNow entities based on the imported data.

At 410, a check is made to determine whether the processing of the selected topic is successful. When the processing of the selected topic is successful, the state of the selected topic is marked as “completed”, at 412. When the processing of the selected topic is not successful, the state of the selected topic is marked as “error”, at 414. When the processing of the selected topic is not successful, the retry operation is performed for a predefined number of times. At 416, a check is made to determine whether the maximum retry count of the selected topic has reached. In this example, the maximum retry count/predefined number can be configurable. When the maximum retry count of the selected topic is reached, the processing of the selected topic may be terminated. When the maximum retry count of the selected topic is not reached, the selected job queue topic is inserted into the job queue table with “error” state so that this topic remains in the queue until a thread to process it is available. Thus, each job queue topic in the job queue table is selected and processed based on the available threads.

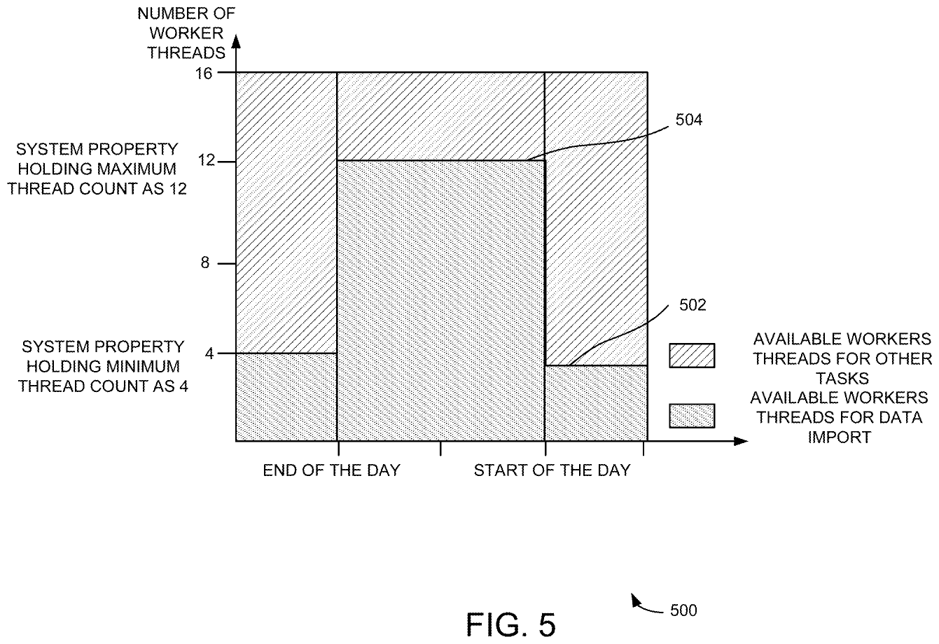

FIG. 5 is an example graph 500, depicting a number of worker threads allocated for the data import based on other activities running on the third-party cloud-based platform. As described in FIG. 4, gatekeeping may be performed on the basis of a configurable parameter in a third-party cloud-based platform (e.g., ServiceNow) under a system property. This is one kind of balancing act that the third-party cloud-based platform instance has to make in between data import worker threads and worker threads required for the rest of the tasks on the instance. With a configuration parameter, this balance is made but only one time. If the balance has to be changed for some reason, the third-party cloud-based platform instance administrator will have to manually change this configuration parameter to take effect.

There can be two situations where this balance needs a change. One being where the attention needs to be given to the other tasks on the instance and the data import from the Aria Automation can be made to wait. On the other hand, there could be a situation where the third-party cloud-based platform instance is not under a heavy load (e.g., be it in the midnight or over the weekend), data import of the Aria Automation can be given more threads to finish quickly. In the examples described herein, there would be two additional configuration parameters holding the maximum threads (e.g., as shown by 504) and the minimum threads (e.g., as shown by 502) that could be allocated to the data import of the Aria Automation plugin.

Also, there would be two additional schedule jobs that makes use of these configuration properties to either bump up the allowed threads for the data import or to reduce the number to the minimum so that according to the rest of the activities on the instance, the number of threads for the data import could be increased to a maximum number or could be reduced to a minimum one. In the example shown in FIG. 5, a maximum number and a minimum number of threads that could be allocated for the data transfer of the integration plugin may be configured as 12 and 4, respectively. In this example, a schedule job 1 may increase the number of threads for the data import to 12 (e.g., the maximum threads 504) at the end of the busy working day as there will be significantly low number of other tasks on the instance. In another example, a schedule job 2 may reduce the number of threads for data import to 4 (e.g., the minimum threads 502) at the start of the busy working day so that the maximum worker threads are available for the other tasks. In other examples, the number of threads for the data import can be allocated between the minimum threads 502 and the maximum threads 504 depending on the other activities being performed on the instance. In some other examples, maximum threads 504 and minimum threads 503 that could be allocated for the data transfer can also be configured as a percentage of the total number of threads available on the third-party cloud-based platform.

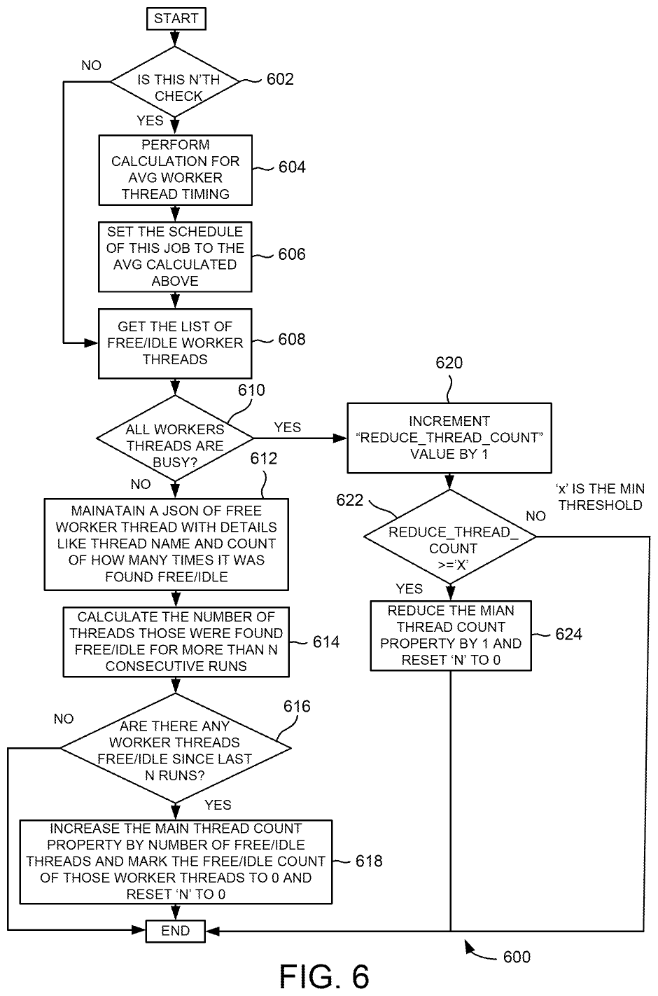

FIG. 6 is a flow diagram illustrating an example method 600 for altering a number of threads for the data import from an integrating product (e.g., VMware Aria® Automation™) to an integrated product (e.g., ServiceNow). Platforms like ServiceNow may store all the active transactions data into a table that could help us understand if the number of allocated threads for data import of the third-party integration plugin needs to be reduced or increased depending upon number of idle/free worker threads available on the platform.

A scheduled job may trigger after every “N” seconds and assess the transaction table to list idle/free worker threads. At 602, a check is made to determine whether it is an Nth check that the transaction table is assessed. When it is Nth check that the transaction table is assessed, at 604, a calculation for average worker thread timing is performed. In an example, the integration plugin may make sure that this calculation does not happen with every run of the scheduled job. At 606, set the schedule of the job to the average calculated above. At 608, a list of free/idle worker threads are obtained. At 610, a check is made to determine whether all the worker threads are busy based on the obtained list. When any of the worker threads is free, at 612, a JSON of free worker thread with details like thread name and count of how many times it was found free/idle may be maintained. At 614, the number of threads that were found free/idle for more than N consecutive runs may be calculated. At 616, a check is made to determine whether there are any worker threads free/idle since last N runs. When there are any worker threads free/idle since last N runs, at 618, the main thread count property may be increased by the number of free/idle threads and mark the free/idle count of those worker threads to 0 and reset ‘N’ to 0.

When all the worker threads are busy, at 620, the “reduce thread count” for the data import may be incremented, for instance, by 1. The “reduce thread count” may be a system property that helps reducing the number of threads for the data import by 1 if the system was found busy for consecutive Nth time. At 622, a check is made to determine if the “reduce thread count” is greater than or equal to x, where x is the minimum number of threads that can be allocated for data transfer.

When the “reduce thread count” is greater than or equal to x, at 624, the main thread count property may be reduced by 1 and reset ‘N’ to 0. When the “reduce thread count” is less than x, the main thread count system property may decide how many worker threads will import the data.

So far, VMware Aria Automation plugin for ServiceNow performs a data import in parallel threads and also have a gatekeeper to make sure not all resources are utilised just for this data import. On the top that, plugin also provides admin with configurable automation of minimum and maximum worker threads allocation to this data import so that customers can balance the data import performance vs logged in user request traffic efficiently. But still, this needs a manual interventions to provide those minimum and maximum thread limits and plugin would then restricts itself to those boundaries.

Ideally, VMware Aria Automation plugin should gauge the traffic and transactions happening on the platform and auto-calibrate the thread limit so that no one ever has to manually set those limits for the plugin. In this way, even in normal busy day, plugin could get a slot where more worker threads are available and the data import could be made faster and on the other hand even if some upgrade or maintenance activity needs to be carried out in non-business hours, plugin's data import will not hamper that activity and keep the worker thread count for the same to minimum.

ServiceNow maintains all the active transaction information in the table “v_transaction” along with the worker thread information that is driving this transaction. This table can help plugin identify how many worker threads are performing transaction and how many are in idle state. Plugin will not take action as soon as some change is noticed in the statistics of this table as there could be a worker thread that just got free from previous transaction and is planned for the next one, but plugin checks it in between and considers it as idle thread. Plugin will keep collecting the statistics of the worker threads and active transactions and only after few iterations, it will take a call whether the worker thread is really idle or was in an intermediate state. Once it is confirmed that no activity is being allocated to that thread, the plugin will increase the number of threads allocated for data import by one (or as many threads as the plugin finds idle since few iterations of checks).

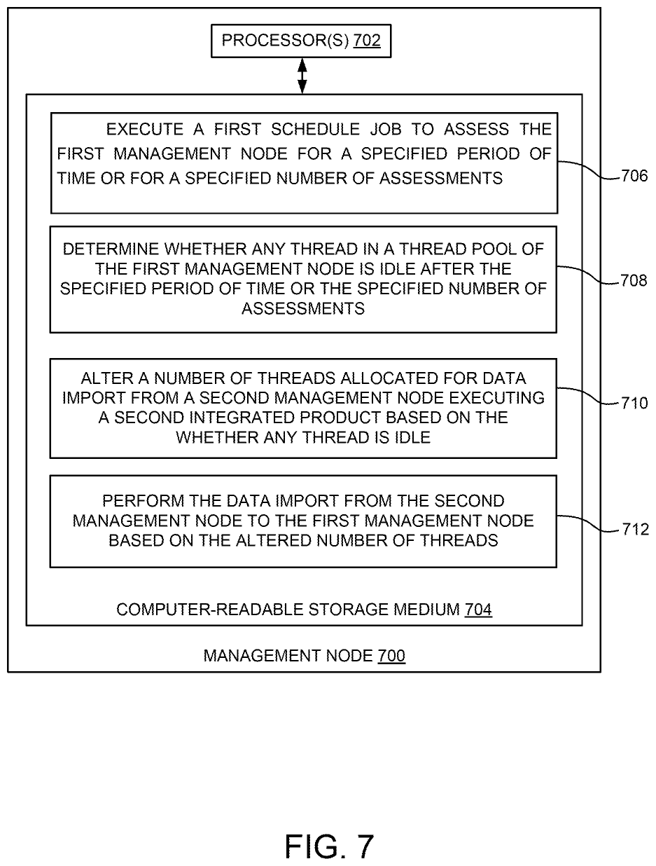

FIG. 7 is a block diagram of an example management node 700 (e.g., a physical server, a virtual machine, or the like) including non-transitory computer-readable storage medium 704 storing instructions to alter a number of threads allocated for data import from a second integrated product to a first integrated product. Management node 700 may include a processor 702 and computer-readable storage medium 704 communicatively coupled through a system bus. Processor 702 may be any type of central processing unit (CPU), microprocessor, or processing logic that interprets and executes computer-readable instructions stored in computer-readable storage medium 704. Computer-readable storage medium 704 may be a random-access memory (RAM) or another type of dynamic storage device that may store information and computer-readable instructions that may be executed by processor 702. For example, computer-readable storage medium 704 may be synchronous DRAM (SDRAM), double data rate (DDR), Rambus® DRAM (RDRAM), Rambus® RAM, etc., or storage memory media such as a floppy disk, a hard disk, a CD-ROM, a DVD, a pen drive, and the like. In an example, computer-readable storage medium 704 may be a non-transitory computer-readable medium. In an example, computer-readable storage medium 704 may be remote but accessible to management node 700.

Computer-readable storage medium 704 may store instructions 706, 708, 710, 712, 714, and 716. Instructions 706 may be executed by processor 702 to execute, via an integration plugin installed on a first integrated product running in the first management node, a first schedule job to assess the first management node for a specified period of time or for a specified number of assessments.

Instructions 708 may be executed by processor 702 to determine, via the integration plugin, whether any thread in a thread pool of the first management node is idle after the specified period of time or the specified number of assessments. In an example, a transaction table that stores statistics data representing active transactions in the first management node and information of threads that are processing the active transactions is assessed. Based on the assessment, it is determined whether the thread is idle.

Instructions 710 may be executed by processor 702 to alter, via the integration plugin, a number of threads allocated for data import from a second management node executing a second integrated product based on the whether any thread is idle. In an example, instructions to alter the number of threads allocated for data import may include instructions to:
after the specified period of time or the specified number of assessments, when one or more threads are found idle, increasing a number of threads for the data
import by allocating the one or more threads that are found idle, and when no thread is found idle, reducing the number of threads for the data import by
releasing back one or more threads to perform other operations in the first management node.

In some examples, instructions to alter the number of threads allocated for data import may include instructions to configure a maximum number and a minimum number of threads that could be allocated for the data import of the integration plugin, and based on other operations being carried out in the first management node, increase the number of threads up to the maximum number that could be allocated for the data import or reducing the number of threads up to the minimum number that could be allocated for the data import. In this example, traffic data and transaction data that are being performed in the first management node are evaluated, and the maximum number and the minimum number of threads that could be allocated for the data import may be auto calibrated based on the traffic data and the transaction data.

Instructions 712 may be executed by processor 702 to perform, via the integration plugin, the data import from the second management node to the first management node based on the altered number of threads. In an example, a second schedule job that invokes a job queue by inserting different topics into the job queue and triggers a business rule to import the data for each topic in the job queue may be executed. Further, the data import may be performed for each topic from the second management node to the first management node by processing the topics in parallel using the altered number of threads.

In an example, instructions to perform the data import from the second management node to the first management node comprise instructions to:
obtain an API response from the second management node by querying the second management node using an application program interface (API) call, the API response comprising the data associated with the second integrated product,
parse the API response,
convert the parsed API response into a defined format corresponding to the first integrated product, and
persist the converted API response in a database associated with the first integrated product by making a platform call that enables the integration plugin to interact with the database.

In other examples, instructions to perform the data import for each topic may include instructions to:
determine, via the second schedule job, a number of available threads for the data import based on the altered number of threads and the number of threads being occupied for the data import,
select, via the second schedule job, one or more topics for performing the data import based on the number of available threads, and
trigger, via the second schedule job, the business rule to perform the data import for the selected topics by occupying the available threads.

Computer-readable storage medium 704 may store instructions to enable the management functions of the second integrated product to be performed through the first integrated product using the imported data.

The above-described examples are for the purpose of illustration. Although the above examples have been described in conjunction with example implementations thereof, numerous modifications may be possible without materially departing from the teachings of the subject matter described herein. Other substitutions, modifications, and changes may be made without departing from the spirit of the subject matter. Also, the features disclosed in this specification (including any accompanying claims, abstract, and drawings), and any method or process so disclosed, may be combined in any combination, except combinations where some of such features are mutually exclusive.

The terms “include,” “have,” and variations thereof, as used herein, have the same meaning as the term “comprise” or appropriate variation thereof. Furthermore, the term “based on”, as used herein, means “based at least in part on.” Thus, a feature that is described as based on some stimulus can be based on the stimulus or a combination of stimuli including the stimulus. In addition, the terms “first” and “second” are used to identify individual elements and may not meant to designate an order or number of those elements.

The present description has been shown and described with reference to the foregoing examples. It is understood, however, that other forms, details, and examples can be made without departing from the spirit and scope of the present subject matter that is defined in the following claims.

What is claimed is:

1. A method for leveraging management functions performed by different integrated products, comprising:
executing, using an integration plugin installed on a first integrated product running in a first management node, a first schedule job to assess the first management node for a specified period of time or for a specified number of assessments;
determining, using the integration plugin, whether a thread in a thread pool of the first management node is idle after the specified period of time or the specified number of assessments;
altering, using the integration plugin, a number of threads allocated for data transfer between a second management node executing a second integrated product and the first management node based on the whether the thread is idle; and
performing, using the integration plugin, the data transfer between the second management node and the first management node based on the altered number of threads.

2. The method of claim 1, further comprising:
enabling to perform the management functions of the second integrated product through the first integrated product using the transferred data.

3. The method of claim 1, wherein altering the number of threads allocated for the data transfer comprises:
increasing the number of threads allocated for the data transfer between the second management node and the first management node when the thread is found idle in the first management node after the specified period of time or the specified number of assessments.

4. The method of claim 1, wherein altering the number of threads allocated for the data transfer comprises:
reducing the number of threads allocated for the data transfer between the second management node and the first management node when no thread is found idle in the first management node after the specified period of time or the specified number of assessments.

5. The method of claim 1, wherein performing the data transfer between the second management node and the first management node comprises:
obtaining an API response from the second management node by querying the second management node using an application program interface (API) call, the API response comprising the data associated with the second integrated product;
parsing the API response;
converting the parsed API response into a defined format corresponding to the first integrated product; and
persisting the converted API response in a database associated with the first integrated product by making a platform call that enables the integration plugin to interact with the database.

6. The method of claim 1, wherein performing the data transfer between the second management node and the first management node comprises:
executing a second schedule job that invokes a job queue by inserting different topics into the job queue and triggers a business rule to import the data for each topic in the job queue; and
performing the data import for each topic from the second management node to the first management node by processing the topics in parallel using the altered number of threads.

7. The method of claim 6, wherein performing the data import for each topic comprises:
determining, by the second schedule job, a number of available threads for the data import based on the altered number of threads and the number of threads being occupied for the data import;
selecting, by the second schedule job, one or more topics for performing the data import based on the number of available threads; and
triggering, by the second schedule job, the business rule to perform the data import for the selected topics by occupying the available threads.

8. The method of claim 1, wherein determining whether the thread is idle comprises:
assessing a transaction table that stores statistics data representing active transactions in the first management node and information of threads that are processing the active transactions; and
determining whether the thread is idle based on the assessment.

9. The method of claim 1, wherein altering the number of threads allocated for the data transfer comprises:
configuring a maximum number and a minimum number of threads that could be allocated for the data transfer of the integration plugin; and
based on other operations being carried out in the first management node, increasing the number of threads up to the maximum number that could be allocated for the data transfer or reducing the number of threads up to the minimum number that could be allocated for the data transfer.

10. The method of claim 9, wherein configuring the maximum number and the minimum number of threads that could be allocated to the data transfer comprises:
evaluating traffic data and transaction data that are being performed in the first management node; and
auto-calibrate the maximum number and the minimum number of threads that could be allocated for the data transfer based on the traffic data and the transaction data.

11. A management node comprising:
a processor;
memory coupled to the processor;
a first cloud-based automation platform running in the memory;
an integration plugin installed on the first cloud-based automation platform to leverage functionalities of a second cloud-based automation platform through the first cloud-based automation platform, the integration plugin being operable to:
execute a first schedule job to assess the management node for a specified period of time or for a specified number of assessments;
determine whether a thread in a thread pool of the management node is idle after the specified period of time or the specified number of assessments;
alter a number of threads allocated for data transfer with the second cloud-based automation platform based on the whether the thread is idle; and
perform the data transfer between the second cloud-based automation platform and the first cloud-based automation platform based on the altered number of threads.

12. The management node of claim 11, wherein the integration plugin is to:
enable the management functions of the second cloud-based automation platform to be performed through the first cloud-based automation platform using the transferred data.

13. The management node of claim 11, wherein the integration plugin is to:
increase the number of threads allocated for the data transfer between the second cloud-based automation platform and the first cloud-based automation platform when the thread is found idle in the management node after the specified period of time or the specified number of assessments.

14. The management node of claim 11, wherein the integration plugin is to:
reduce the number of threads allocated for the data transfer between the second cloud-based automation platform and the first cloud-based automation platform when no thread is found idle in the management node after the specified period of time or the specified number of assessments.

15. The management node of claim 11, wherein the integration plugin comprises:
an API module to obtain an API response from the second cloud-based automation platform by querying the second cloud-based automation platform using an application program interface (API) call, the API response comprising the data associated with the second cloud-based automation platform;
a parser to parse the API response;
a data converter to convert the parsed API response into a defined format corresponding to the first cloud-based automation platform; and
a persisting unit to persist the converted API response in a database associated with the first cloud-based automation platform by making a platform call that enables the integration plugin to interact with the database.

16. The management node of claim 11, wherein the integration plugin comprises:
a second schedule job, when executed, is to:
invoke a job queue by inserting different topics into the job queue and triggers a business rule to import the data for each topic in the job queue; and
perform the data import for each topic from the second cloud-based automation platform to the first cloud-based automation platform by processing the topics in parallel using the altered number of threads.

17. The management node of claim 16, wherein the second schedule job, when executed, is to:
perform the data import for each topic by:
determining a number of available threads for the data import based on the altered number of threads and the number of threads being occupied for the data import;
selecting one or more topics for performing the data import based on the number of available threads; and
triggering the business rule to perform the data import for the selected topics by occupying the available threads.

18. The management node of claim 11, wherein the integration plugin is to:
execute the first schedule job to assess a transaction table that stores statistics data representing active transactions in the management node and information of threads that are processing the active transactions; and
determine whether the thread is idle based on the assessment.

19. The management node of claim 11, wherein the integration plugin is to:
configuring a maximum number and a minimum number of threads that could be allocated for the data transfer of the integration plugin; and
based on other operations being carried out in the management node, increase the number of threads up to the maximum number that could be allocated for the data transfer or reduce the number of threads up to the minimum number that could be allocated for the data transfer.

20. The management node of claim 19, wherein the integration plugin is to:
evaluate traffic data and transaction data that are being performed in the management node; and
auto-calibrate the maximum number and the minimum number of threads that could be allocated for the data transfer based on the traffic data and the transaction data.

21. A non-transitory computer readable storage medium storing instructions executable by a processor of a first management node to:
execute, via an integration plugin installed on a first integrated product running in the first management node, a first schedule job to assess the first management node for a specified period of time or for a specified number of assessments;
determine, via the integration plugin, whether any thread in a thread pool of the first management node is idle after the specified period of time or the specified number of assessments;
alter, via the integration plugin, a number of threads allocated for data import from a second management node executing a second integrated product based on the whether any thread is idle; and
perform, via the integration plugin, the data import from the second management node to the first management node based on the altered number of threads.

22. The non-transitory computer readable storage medium of claim 21, further comprising instructions to:
enable the management functions of the second integrated product to be performed through the first integrated product using the imported data.

23. The non-transitory computer readable storage medium of claim 21, wherein instructions to alter the number of threads allocated for data import comprise instructions to:
after the specified period of time or the specified number of assessments,
when one or more threads are found idle, increasing a number of threads for the data import by allocating the one or more threads that are found idle; and
when no thread is found idle, reducing the number of threads for the data import by releasing back one or more threads to perform other operations in the first management node.

24. The non-transitory computer readable storage medium of claim 21, wherein instructions to perform the data import from the second management node to the first management node comprise instructions to:
obtain an API response from the second management node by querying the second management node using an application program interface (API) call, the API response comprising the data associated with the second integrated product;
parse the API response;
convert the parsed API response into a defined format corresponding to the first integrated product; and
persist the converted API response in a database associated with the first integrated product by making a platform call that enables the integration plugin to interact with the database.

25. The non-transitory computer readable storage medium of claim 21, wherein instructions to perform the data import from the second management node to the first management node comprise instructions to:
execute a second schedule job that invokes a job queue by inserting different topics into the job queue and triggers a business rule to import the data for each topic in the job queue; and
perform the data import for each topic from the second management node to the first management node by processing the topics in parallel using the altered number of threads.

26. The non-transitory computer readable storage medium of claim 25, wherein instructions to perform the data import for each topic comprise instructions to:
determine, via the second schedule job, a number of available threads for the data import based on the altered number of threads and the number of threads being occupied for the data import;
select, via the second schedule job, one or more topics for performing the data import based on the number of available threads; and
trigger, via the second schedule job, the business rule to perform the data import for the selected topics by occupying the available threads.

27. The non-transitory computer readable storage medium of claim 21, wherein instructions to determine whether the thread is idle comprise instructions to:
assess a transaction table that stores statistics data representing active transactions in the first management node and information of threads that are processing the active transactions; and
determine whether the thread is idle based on the assessment.

28. The non-transitory computer readable storage medium of claim 21, wherein instructions to alter the number of threads allocated for data import comprise instructions to:
configure a maximum number and a minimum number of threads that could be allocated for the data import of the integration plugin; and
based on other operations being carried out in the first management node, increase the number of threads up to the maximum number that could be allocated for the data import or reducing the number of threads up to the minimum number that could be allocated for the data import.

29. The non-transitory computer readable storage medium of claim 28, wherein instructions to configure the maximum number and the minimum number of threads that could be allocated to the data import comprise instructions to:
evaluate traffic data and transaction data that are being performed in the first management node; and
auto-calibrate the maximum number and the minimum number of threads that could be allocated for the data import based on the traffic data and the transaction data.
